(19) United States
(12) Patent Application Publication
(10) Pub. No.: US 2015/0062962 A1
(43) Pub. Date: Mar. 5, 2015

(54) LIGHTING APPARATUS

(71) Applicant: Lextar Electronics Corporation, Hsinchu (TW)

(72) Inventor: Ching-Yao LIN, New Taipei City (TW)

(73) Assignee: Lextar Electronics Corporation, Hsinchu (TW)

(21) Appl. No.: 14/149,065

(22) Filed: Jan. 7, 2014

(30) Foreign Application Priority Data
Sep. 5, 2013 (TW) 102132039

(51) Int. Cl. F21V 8/00

(52) U.S. Cl. CPC G02B 6/005; G02B 6/0013
USPC 362/606

(57) ABSTRACT

A lighting apparatus includes a lighting element and a light guide plate. The light guide plate includes an optical waveguide zone and a wavelength converting zone. The optical waveguide zone is disposed on the lighting element, and includes an upper total reflection surface, a lower total reflection surface, a light incident surface and a first light outgoing surface. The upper and lower total reflection surfaces are disposed on opposite sides of the optical waveguide zone. The light incident surface is positioned on a partial area of the lower total reflection surface, and positioned on the optical path of the light emitted by the lighting element. The first light outgoing surface connects the upper and lower total reflection surfaces. The wavelength converting zone is adjoined to the first light outgoing surface, and includes a wavelength converting material therein.

### RELATED APPLICATIONS

This application claims priority to Taiwan Application Serial Number 102132039, filed Sep. 5, 2013, which is herein incorporated by reference.

### BACKGROUND

1. Technical Field

Embodiments of the present invention relates to a lighting apparatus.

2. Description of Related Art

Because a light emitting diodes (LED) has advantages such as low power-consumption, it has become a popular lighting device and been widely applied in illumination and backlighting of display. In order to increase the lighting range of the LED, a light guide plate is typically employed in which the LED can be disposed on the lateral surface of the light guide plate. When the LED emits light, the light enters the light guide plate through the lateral surface of the light guide plate, and it goes out of the light guide plate through the upper surface of the light guide plate.

Although the light can be uniformly distributed in view of the upper surface of the light guide plate, the requirements of exhibiting a particular pattern through the light guide plate is simply not satisfactory.

### SUMMARY

One aspect of the present invention is to provide a lighting apparatus that can control the light to show a particular pattern.

In accordance with one embodiment of the present invention, the lighting apparatus includes at least one lighting element and a light guide plate. The lighting element is used for emitting a first light having a first wavelength. The light guide plate includes an optical waveguide zone and a wavelength converting zone. The optical waveguide zone is disposed on the lighting element for allowing the first light traveling within the optical waveguide zone by total reflection. The optical waveguide zone includes an upper total reflection surface, a lower total reflection surface, a light incident surface and a first light outgoing surface. The upper total reflection surface and the lower total reflection surface are parallel to each other and disposed on opposite sides of the optical waveguide zone. The light incident surface is positioned on a partial area of the lower total reflection surface, and positioned on an optical path of the first light emitted by the lighting element, so as to allow the first light to go into the optical waveguide zone through the light incident surface and to travel within the optical waveguide zone by total reflection. The first light outgoing surface is adjoined to the upper total reflection surface and the lower total reflection surface. The wavelength converting zone is adjoined to the first light outgoing surface for receiving the first light from the first light outgoing surface. The wavelength converting zone includes a wavelength converting material therein for converting a portion of the first light to be a second light having a second wavelength that is greater than the first wavelength. The wavelength converting zone has a second light outgoing surface, so as to allow the first light and the second light to go out of the light guide plate and to mix as a third light.

In the foregoing embodiment, the light emitted by the lighting element can travel into the wavelength converting zone by total reflection, and can go out of the light guide plate through the wavelength converting zone. In other words, in a top view of the light guide plate, the optical waveguide zone is dark, and the wavelength converting zone is bright. Therefore, the manufacturer can design the pattern of the wavelength converting zone to control the light to show a particular pattern.

Further, the wavelength converting material can lengthen the wavelength of the light. When the wavelength is lengthened, the refractive index of the medium (such as the material of the wavelength converting zone) can be reduced, and the critical angle can be therefore reduced, so as to prevent the light traveling within the wavelength converting zone from total reflection when it arrives at the second light outgoing surface, thereby allowing more lights to go out of the light guide plate through the second light outgoing surface, and improving the brightness and the lighting efficiency of the lighting apparatus.

Moreover, because the wavelength converting zone can be bright without any lighting element being disposed on the wavelength converting zone, the amount of the lighting elements can be reduced, such that the cost can be reduced as well.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of a lighting apparatus in accordance with one embodiment of the present invention;

FIG. 2 is a side view of the lighting apparatus in FIG. 1 illustrating the optical path thereof;

FIG. 3 is a side view of the lighting apparatus illustrating the optical path thereof in accordance with another embodiment of the present invention; and

FIG. 4 is a perspective view of the lighting apparatus in accordance with another embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

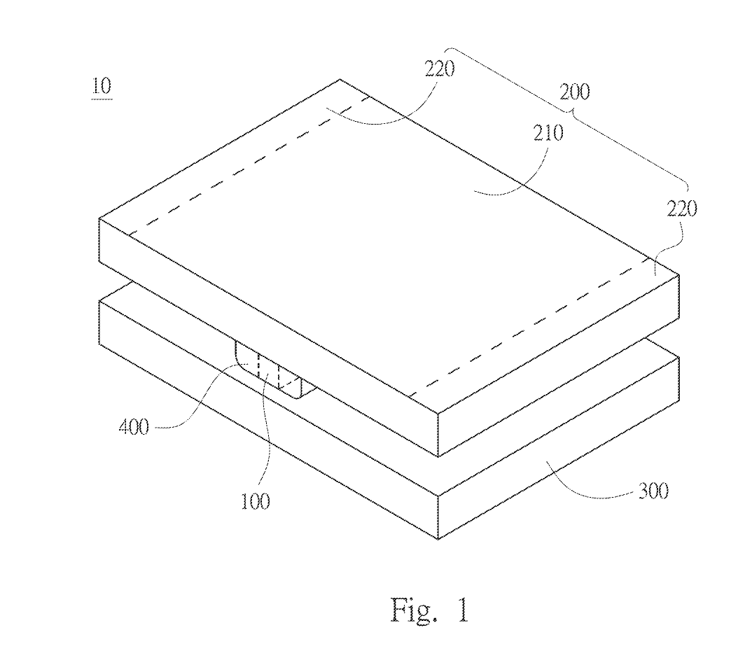

FIG. 1 is a perspective view of a lighting apparatus 10 in accordance with one embodiment of the present invention. As shown in FIG. 1, the lighting apparatus 10 includes at least one lighting element 100, a light guide plate 200 and a circuit board 300. The lighting element 100 is disposed between the light guide plate 200 and the circuit board 300. In other words, the light guide plate 200 is disposed above the lighting element 100, and the circuit board 300 is disposed under the lighting element 100.

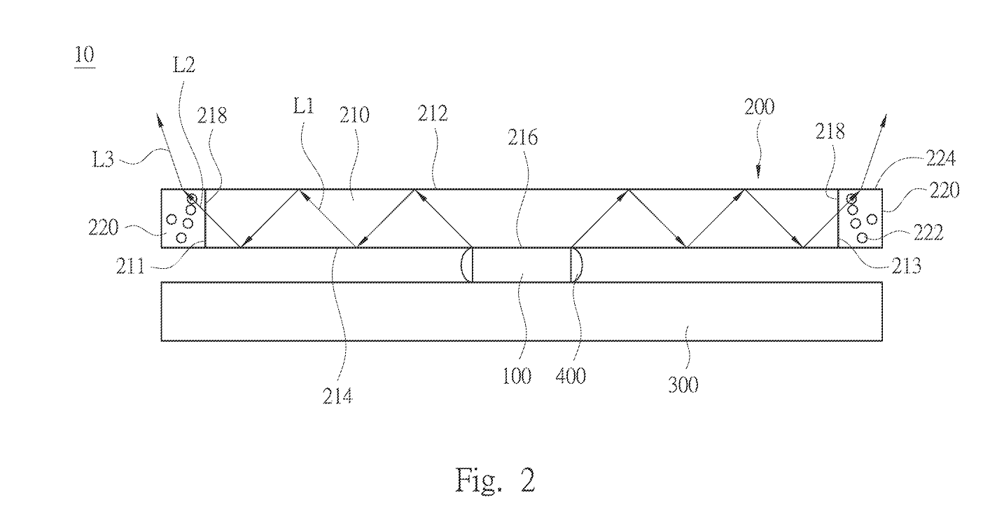

FIG. 2 is a side view of the lighting apparatus 10 in FIG. 1 illustrating the optical path thereof. As shown in FIG. 2, the light guide plate 200 includes an optical waveguide zone 210 and a wavelength converting zone 220. The optical waveguide zone 210 is disposed on the lighting element 100. The optical waveguide zone 210 includes an upper total reflection surface 212, a lower total reflection surface 214, a light incident surface 216 and a first light outgoing surface 218. The upper total reflection surface 212 and the lower total reflection surface 214 are parallel to each other and disposed on opposite sides of the optical waveguide zone 210. The upper total reflection surface 212 and the lower total reflection surface 214 can reflect the light, so as to prevent the light from going out of the optical waveguide zone 210 through the upper total reflection surface 212 and the lower total reflection surface 214. The light incident surface 216 is positioned on a partial area of the lower total reflection surface 214. The light incident surface 216 is positioned on an optical path of the light emitted by the lighting element 100, such that the light emitted by the lighting element 100 can go into the optical waveguide zone 210. The first light outgoing surface 218 is adjoined to the upper total reflection surface 212 and the lower total reflection surface 214.

The wavelength converting zone 220 is adjoined to the first light outgoing surface 218. The wavelength converting zone 220 includes a second light outgoing surface 224. The second light outgoing surface 224 is adjoined to the upper total reflection surface 212 of the optical waveguide zone 210. The wavelength converting zone 220 includes a wavelength converting material 222 therein. The wavelength converting material 222 can scatter the light for facilitating the light to go out of the second light outgoing surface 224. The wavelength converting material 222 can also lengthen the wavelength of the light. When the wavelength is lengthened, the refractive index of the medium (such as the material of the wavelength converting zone 220) can be reduced, and the critical angle can be therefore reduced, so as to prevent the light traveling within the wavelength converting zone 220 from total reflection when it arrives at the second light outgoing surface 224, thereby allowing more lights to go out of the light guide plate 200 through the second light outgoing surface 224, and improving the brightness and the lighting efficiency of the lighting apparatus 10.

Because the upper total reflection surface 212 and the lower total reflection surface 214 allow the first light L1 emitted by the lighting element 100 to travel within the optical waveguide zone 210 by total reflection, they can prevent the first light L1 from going out of the optical waveguide zone 210 through the upper total reflection surface 212 or the lower total reflection surface 214. Therefore, the optical waveguide zone 210 is dark. Further, because the light can go out of the light guide plate 200 through the second light outgoing surface 224, the wavelength converting zone 220 is bright. In other words, the brightness of the optical waveguide zone 210 is not equal to the brightness of the wavelength converting zone 220, so that the viewer may visually percept that the wavelength converting zone 220 is lighting, while the optical waveguide zone 210 is not lighting. As such, the pattern of the wavelength converting zone 220 can be designed based on the necessity, so that the lighting apparatus 10 can show various lighting patterns.

Moreover, the wavelength converting zone 220 can be bright without any lighting element 100 being disposed thereon, and instead, the lighting element 100 is only disposed on the optical waveguide zone 210, such as the middle area of the light guide plate 200. Therefore, the amount of the lighting elements 100 can be reduced, such that the cost can be reduced as well.

As shown in FIG. 2, during operation, the lighting element 100 emits a first light L1 having a first wavelength. The first light L1 can go into the optical waveguide zone 210 through the light incident surface 216. The upper total reflection surface 212 and the lower total reflection surface 214 can totally reflect the first light L1 within the optical waveguide zone 210, so that the first light L1 can travel within the optical waveguide zone 210 by total reflection. When the first light L1 arrives at the first light outgoing surface 218, the first light L1 can go into the wavelength converting zone 220 through the first light outgoing surface 218. When the first light L1 travels within the wavelength converting zone 220, a portion of the first light L1 is converted to be a second light L2 having a second wavelength. The remaining non-converted first light L1 can travel within the wavelength converting zone 220 as well. The wavelength converting material 222 is scatterable for light, so as to facilitate the third light L3 mixed by the first light L1 and the second light L2 to go out of the light guide plate 200. Moreover, the wavelength of the second light L2 is greater than the wavelength of the first light L1, and because the lengthened wavelength can reduce the critical angle, the third light L3 having the wavelength greater than which of the first light L1 can go out of the light guide plate 200 more easily.

In some embodiments, the upper total reflection surface 212 and the lower total reflection surface 214 can be, but are not limited to be, implemented by coating reflective material, such as Argentum, on the upper and lower surfaces of the optical waveguide zone 210.

In some embodiments, the second light outgoing surface 224 is a rough surface. In other words, the second light outgoing surface 224 includes an uneven microstructure thereon. As such, the incident angle of which the light go out of the light guide plate 200 through the second light outgoing surface 224 can be reduced, thereby preventing total reflection occurring at the second light outgoing surface 224, so as to facilitate the light to go out of the light guide plate 200.

In some embodiments, the wavelength converting zone 220 and the optical waveguide zone 210 are linearly arranged along the same direction. In other words, the wavelength converting zone 220 and the optical waveguide zone 210 are arranged along a straight line. In some embodiments, the second light outgoing surface 224 is not only adjoined to the upper total reflection surface 212, but also is substantially parallel to the upper total reflection surface 212. In other words, the second light outgoing surface 224 and the upper total reflection surface 212 are coplanar.

In some embodiments, the optical waveguide zone 210 is a linear area having a first end 211 and a second end 213. The first end 211 and the second end 213 are opposite to each other, and they respectively have the first light outgoing surfaces 218. The wavelength converting zone 220 is adjoined to the first end 211, and another wavelength converting zone 220 is adjoined to the second end 213. Therefore, as shown in FIG. 1, when the lighting element 100 is lighting, the lighting apparatus 10 can show the pattern in which the left and right sides are bright, and the middle area is dark.

In some embodiments, as shown in FIG. 2, the lighting element 100 is disposed on the circuit board 300, and is electrically connected to the circuit board 300. As such, the lighting element 100 can be driven by the driving components (not shown) on the circuit board 300 to emit a light.

In some embodiments, as shown in FIG. 2, the lighting apparatus 10 includes an encapsulant 400. The encapsulant 400 covers the lighting element 100 for protecting the lighting element 100. The encapsulant 400 adheres the lighting element 100 to the light incident surface 216 of the optical waveguide zone 210. In particular, the encapsulant 400 is adhered between the light incident surface 216 of the optical waveguide zone 210 and the circuit board 300.

In some embodiments, the wavelength converting material 222 can be phosphor, dye, pigment or any combination thereof. The wavelength converting material 222 can be excited by the light from the lighting element 100, so as to lengthen the wavelength of the light. In some embodiments, the lighting element 100 can be an LED. Preferably, the lighting element 100 can be the LED emitting the light having short wavelength, so as to excite the wavelength converting material 222. For example, the lighting element 100 can be a blue LED or an UV LED. In some embodiments, because the light guide plate 200 has a wavelength converting zone 220, a wavelength converting material in the lighting element 100 can be omitted. In other words, the lighting element 100 can be an LED die without encapsulated by the wavelength converting material. Moreover, the diameter of particles of the wavelength converting material 222 is scatterable for the incident light, so as to facilitate the light to go out of the light guide plate 200.

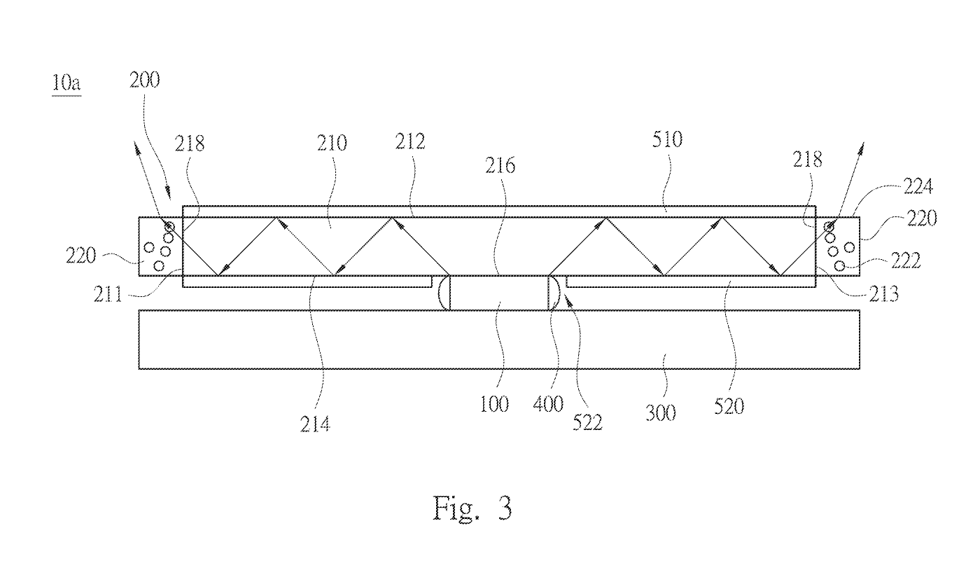

FIG. 3 is a side view of the lighting apparatus 10a illustrating the optical path thereof in accordance with another embodiment of the present invention. As shown in FIG. 3, the main difference between this embodiment and the foregoing embodiment is that: the lighting apparatus 10a includes two reflective sheets 510 and 520. The reflective sheet 510 is disposed on the upper total reflection surface 212, so as to totally reflect the light arriving at the upper total reflection surface 212. The reflective sheet 520 is disposed on the lower total reflection surface 214, so as to totally reflect the light arriving at the lower total reflection surface 214. The reflective sheets 510 and 520 can further prevent the light from going out of the optical waveguide zone 210 through the upper total reflection surface 212 and the lower total reflection surface 214.

In some embodiments, the reflective sheet 520 has an opening 522. The light incident surface 216 is exposed on the opening 522, and a portion of the lighting element 100 is positioned in the opening 522. In this configuration, the light emitted by the lighting element 100 can go into the optical waveguide zone 210 through the light incident surface 216 without blocking by the reflective sheet 520.

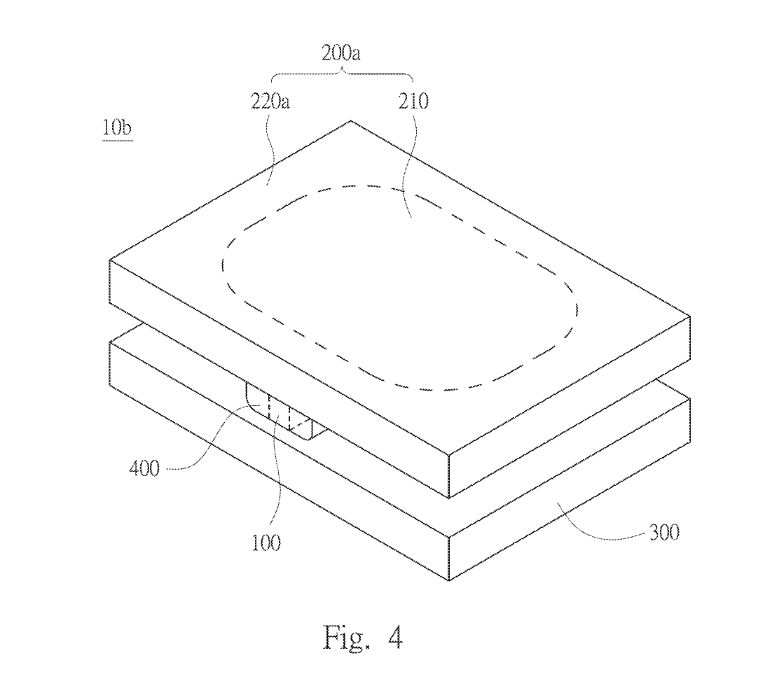

FIG. 4 is a perspective view of the lighting apparatus 10b in accordance with another embodiment of the present invention. As shown in FIG. 4, the main difference between the lighting apparatus 10b and the lighting apparatus 10 in FIG. 1 is that the wavelength converting zone 220a includes the shape different from which of the wavelength converting zone 220 in FIG. 1. More particularly, the wavelength converting zone 220a is an annular structure, and the optical waveguide zone 210 is surrounded by the wavelength converting zone 220a. In other embodiments, the wavelength converting zone 220a can be in other shape, such as triangle or hexagon and so on.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A lighting apparatus, comprising:
at least one lighting element for emitting a first light having a first wavelength; and
a light guide plate comprising:
an optical waveguide zone disposed on the lighting element for allowing the first light traveling within the optical waveguide zone by total reflection, the optical waveguide zone comprising:
an upper total reflection surface;
a lower total reflection surface, the upper total reflection surface and lower total reflection surface being parallel to each other and disposed on opposite sides of the optical waveguide zone;
a light incident surface positioned on a partial area of the lower total reflection surface, and positioned on an optical path of the first light emitted by the lighting element, so as to allow the first light to go into the optical waveguide zone through the light incident surface and to travel within the optical waveguide zone by total reflection; and
a first light outgoing surface adjoined to the upper total reflection surface and the lower total reflection surface; and
a wavelength converting zone adjoined to the first light outgoing surface for receiving the first light from the first light outgoing surface, wherein the wavelength converting zone comprises a wavelength converting material therein for converting a portion of the first light to be a second light having a second wavelength that is greater than the first wavelength, wherein the wavelength converting zone comprises a second light outgoing surface, so as to allow the first light and the second light to go out of the light guide plate and to mix as a third light.

2. The lighting apparatus of claim 1, further comprising a plurality of reflective sheets respectively disposed on the upper total reflection surface and the lower total reflection surface for allowing lights traveling by total reflection.

3. The lighting apparatus of claim 2, wherein the second light outgoing surface is adjoined to and parallel to the upper total reflection surface, and the second light outgoing surface is a rough surface.

4. The lighting apparatus of claim 1, wherein the wavelength converting zone and the optical waveguide zone are linearly arranged along the same direction.

5. The lighting apparatus of claim 4, wherein the optical waveguide zone is a linear area having a first end and a second end, wherein the first end and the second end respectively have the first light outgoing surfaces, and the wavelength converting zone is adjoined to the first end and the second end.

6. The lighting apparatus of claim 1, wherein the optical waveguide zone is surrounded by the wavelength converting zone.

7. The lighting apparatus of claim 1, further comprising a circuit board disposed under the light guide plate, so as to allow the lighting element to be disposed on and electrically connected to the circuit board.

8. The lighting apparatus of claim 7, wherein the lighting element is a light emitting diode.

9. The lighting apparatus of claim 1, wherein the wavelength converting material is selected from the group consisting of phosphor, dye, pigment and combinations thereof.

10. The lighting apparatus of claim 9, further comprising:
an encapsulant covering the lighting element and adhering the lighting element to the light incident surface of the optical waveguide zone.
